(19) United States
(12) Patent Application Publication
(10) Pub. No.: US 2015/0334523 A1
(43) Pub. Date: Nov. 19, 2015

(54) A METHOD, AN APPARATUS AND A SYSTEM FOR ESTIMATING A NUMBER OF PEOPLE IN A LOCATION

(71) Applicant: INNORANGE OY, HELSINKI (FI)

(72) Inventors: Antti Tuomas LAPPETELAINEN, ESPOO (FI); Samuli Juhani SILANTO, HELSINKI (FI); Jukka Olavi HONKOLA, ESPOO (FI); David Munoz SANCHEZ, ESPOO (FI); Mario Alberto Llorente LOPEZ, ESPOO (FI)

(73) Assignee: INNORANGE OY, HELSINKI (FI)

(21) Appl. No.: 14/382,077

(22) PCT Filed: Feb. 28, 2013
(86) PCT No.: PCT/FI2013/050225

§ 371 Date: Aug. 29, 2014

(30) Foreign Application Priority Data
Mar. 1, 2012 (FI) 20125229

(51) Int. Cl. H04W 4/02; H04W 4/00

(52) U.S. Cl. CPC H04W 4/02; H04W 4/008; H04W 4/021

(57) ABSTRACT

An apparatus, method, system and computer program for estimating a number of people within a location. The estimation includes obtaining a plurality of estimates of the number of mobile transmitters and respective estimates of the number of people within a first location during a first period of time, and determining a mapping function providing a mapping between an estimate of the number of mobile transmitters at a location and an estimate of the number of people at the location on basis of the plurality of estimates of the number of mobile transmitters and the respective plurality of estimates of the number of people for determination of a second estimate of the number of people within a second location during a second period of time on basis of a second estimate of the number of mobile transmitters obtained at the second location during the second period of time.

### FIELD OF THE INVENTION

The invention relates to estimation of the number of persons in a location. In particular, the invention relates to a method, an apparatus, a system and computer program making use of estimated number of mobile radio transmitters together with auxiliary information, such as information derived on basis of image analysis, for estimating a number of persons in a location and/or for calibration of the estimation

### BACKGROUND OF THE INVENTION

A growing number of industries are benefitting on detailed people flow management and monitoring, e.g. in form of customer flow information. Such industries include digital signage, retail, theme parks, public transport, fairs, museums, etc. Examples of solutions addressing people flow management include traditional “person counter” solutions and e.g. elevator led based solutions.

Recently, solutions utilizing radio connectivity as basis of the person counting have been introduced. Radio-based solutions may utilize local connectivity such as WiFi or Bluetooth with the assumption that a sensed WiFi transmitter or Bluetooth transmitter corresponds to a person carrying a device as an origin of the respective transmission. While such radio-based solutions are gaining ground, they suffer from inaccuracies due to the fact that typically only part of the devices equipped with a WiFi or Bluetooth transmitter/transceiver are in active state, thereby leading to an incorrect estimate of the actual number of persons.

In parallel, imaging based solutions may be used for person counting. Such solutions may make use of machine vision analysis, e.g. face detection within an image or image analysis of other kind, in order to estimate the number of persons in an image or in a segment of video data. Imaging based solutions have the advantage that they may allow, in addition to straightforward person count estimation, estimation of age and gender of the persons identified in an image. On the other hand, imaging based solutions typically require careful placing of a camera in a fixed position, taking into account light conditions, assumed facial direction of people, etc. thereby resulting in a rather inflexible and possibly also costly solution

### SUMMARY OF THE INVENTION

It is an object of the invention to provide a method, an apparatus, a system and a computer program for reliable but yet cost effective arrangement for estimating a number of persons in a location.

The objects of the invention are reached by an apparatus, a method, a system and a computer program as defined by the respective independent claims.

According to a first aspect of the invention, a first apparatus for estimating a number of people within a location is provided. The first apparatus comprises a detector configured to obtain a plurality of estimates of the number of mobile transmitters and respective estimates of the number of people within a first location during a first period of time, and an estimator configured to determine a mapping function providing a mapping between an estimate of the number of mobile transmitters at a location and an estimate of the number of people at the location on basis of the plurality of estimates of the number of mobile transmitters and the plurality of estimates of the number of people for determination of a second estimate of the number of people within a second location during a second period of time on basis of a second estimate of the number of mobile transmitters obtained at the second location during the second period of time, wherein an estimate of the number of mobile transmitters comprises indications of the number of mobile transmitters of one or more different types.

Moreover, according to the first aspect of the invention, a second apparatus for estimating a number of people within a location is provided. The second apparatus comprises a detector configured to obtain a mapping function configured to provide mapping between an estimate of the number of mobile transmitters at a location and an estimate of the number of people at the location, and to obtain an estimate of the number of mobile transmitters within a second location during a second period of time, wherein an estimate of the number of mobile transmitters comprises indications of the number of mobile transmitters of one or more different types. The second apparatus further comprises an estimator configured to determine an estimate of the number of people within the second location during the second period of time on basis of the estimate of the number of mobile transmitters within the second location during the second period of time by using the mapping function.

According to a second aspect of the invention, a first method for estimating a number of people within a location is provided. The first method comprises obtaining a plurality of estimates of the number of mobile transmitters and respective estimates of the number of people within a first location during a first period of time, and determining a mapping function providing a mapping between an estimate of the number of mobile transmitters at a location and an estimate of the number of people at the location on basis of the plurality of estimates of the number of mobile transmitters and the respective plurality of estimates of the number of people for determination of a second estimate of the number of people within a second location during a second period of time on basis of a second estimate of the number of mobile transmitters obtained at the second location during the second period of time, wherein an estimate of the number of mobile transmitters comprises indications of the number of mobile transmitters of one or more different types.

Moreover, according to the second aspect of the invention, a second method for estimating a number of people is provided, the second method making use of the outcome of the first method. The second method comprises obtaining a mapping function configured to provide mapping between an estimate of the number of mobile transmitters at a location and an estimate of the number of people at the location, obtaining an estimate of the number of mobile transmitters within a second location during a second period of time, and determining an estimate of the number of people within the second location during the second period of time on basis of the estimate of the number of mobile transmitters within the second location during the second period of time by using the mapping function, wherein an estimate of the number of mobile transmitters comprises indications of the number of mobile transmitters of one or more different types.

According to a third aspect of the invention, a system for estimating a number of people within a location is provided. The system comprises a first detector configured to obtain a plurality of estimates of the number of mobile transmitters and respective estimates of the number of people within a first location during a first period of time, a first estimator configured to determine a mapping function providing a mapping between an estimate of the number of mobile transmitters at a location and an estimate of the number of people at the location on basis of the plurality of estimates of the number of mobile transmitters and the plurality of estimates of the number of people for determination of a second estimate of the number of people within a second location during a second period of time on basis of a second estimate of the number of mobile transmitters obtained at the second location during the second period of time, a second detector configured to obtain a mapping function configured to provide mapping between an estimate of the number of mobile transmitters at a location and an estimate of the number of people at the location, and to obtain an estimate of the number of mobile transmitters within a second location during a second period of time; and a second estimator configured to determine an estimate of the number of people within the second location during the second period of time on basis of the estimate of the number of mobile transmitters within the second location during the second period of time by using the mapping function, wherein an estimate of the number of mobile transmitters comprises indications of the number of mobile transmitters of one or more different types.

According to a fourth aspect of the invention, a computer program for estimating a number of people within a location is provided. The computer program comprises one or more sequences of one or more instructions which, when executed by one or more processors, cause an apparatus to at least perform a method in accordance with the second aspect of the invention.

The computer program may be embodied on a volatile or a non-volatile computer-readable record medium, for example as a computer program product comprising at least one computer readable non-transitory medium having program code stored thereon, the program code, which when executed by an apparatus, causes the apparatus at least to perform the operations described hereinbefore for the computer program in accordance with the fourth aspect of the invention.

Embodiments of the invention facilitate improved accuracy of people flow management in context of radio signal based people flow management solutions by making use of auxiliary information to calibrate the estimate of the person count provided by a radio signal based arrangement.

The exemplifying embodiments of the invention presented in this patent application are not to be interpreted to pose limitations to the applicability of the appended claims. The verb “to comprise” and its derivatives are used in this patent application as an open limitation that does not exclude the existence of also unrecited features. The features described hereinafter are mutually freely combinable unless explicitly stated otherwise.

The novel features which are considered as characteristic of the invention are set forth in particular in the appended claims. The invention itself, however, both as to its construction and its method of operation, together with additional objects and advantages thereof, will be best understood from the following detailed description of specific embodiments when read in connection with the accompanying drawings.

### BRIEF DESCRIPTION OF THE DRAWINGS

FIG. 1 schematically illustrates an exemplifying scenario for estimation of the number of people within a location.

FIG. 2 schematically illustrates an apparatus according to an embodiment of the invention.

FIG. 3a schematically illustrates an apparatus according to an embodiment of the invention.

FIG. 3b schematically illustrates an apparatus and an arrangement according to an embodiment of the invention.

FIG. 4 schematically illustrates an apparatus according to an embodiment of the invention.

FIG. 5a schematically illustrates an apparatus according to an embodiment of the invention.

FIG. 5b schematically illustrates an apparatus and an arrangement according to an embodiment of the invention.

FIG. 6 schematically illustrates an apparatus according to an embodiment of the invention.

FIG. 7 schematically illustrates an apparatus according to an embodiment of the invention.

FIG. 8 illustrates a method according to an embodiment of the invention.

FIG. 9 illustrates a method according to an embodiment of the invention.

### DETAILED DESCRIPTION

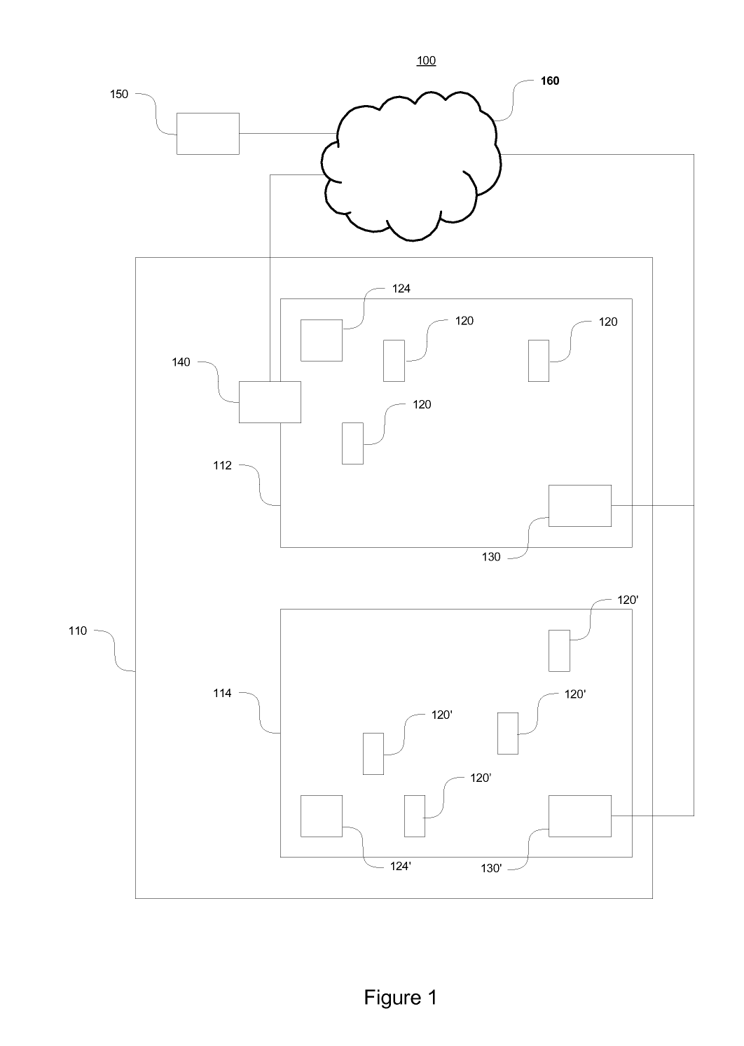

FIG. 1 schematically illustrates an exemplifying scenario 100 for estimation of the number of people within a location. The scenario 100 comprises a physical space 110, which in turn comprises a first location 112 and a second location 114. The physical space 110 may comprise any number of locations that may be considered distinct from each other. However the first location 112 and the second location 114 suffice for the purposes of illustrating an exemplifying scenario serving as an exemplifying use case for the present invention. Moreover, although in the scenario 100 the first location 112 and the second location 114 are depicted as locations within the same physical space, in general case the first and second locations 112, 114 do not necessarily have physical relationship with each other.

The first location 112 comprises a radio detector 130 configured to detect information regarding the mobile transmitters in mobile devices within the first location 112 at predetermined moments of time. The first location 112 further comprises a server apparatus 124, which may be for example a wireless access point with which some of the mobile devices 120 may communicate with. Moreover, the first location 112 comprises an imaging unit 140 configured to capture one or more images of the first location 112 at predetermined moments of time, preferably operating in synchronization with the radio detector 130.

The second location 114 comprises a radio detector 130′ configured to detect information regarding the mobile transmitters in mobile devices 120′ within the second location 114 at predetermined moments of time. The second location 114 further comprises a server apparatus 124′, which may be for example a wireless access point with which some of the mobile devices 120′ may communicate with.

The radio detectors 130, 130′ are connected via a network 160 to an apparatus 150, and the radio detectors 130, 130′ are configured to provide the detected information regarding the radio transmitters in the respective locations to the apparatus 150. Similarly, the imaging unit 140 is connected via the network 160 to the apparatus 150, and the imaging unit 140 is configured to provide the captured images to the apparatus 150. The apparatus 150 is configured to store and/or process the information received from the radio detectors 130, 130′ and from the imaging unit 140.

Note that although the radio detectors 130, 130′, the imaging unit 140 and the apparatus 150 are depicted in the exemplifying arrangement 100 as separate apparatus and/or units, e.g. any combination of the radio detector 130, the imaging unit 140 and the apparatus 150 may be embodied on a single apparatus.

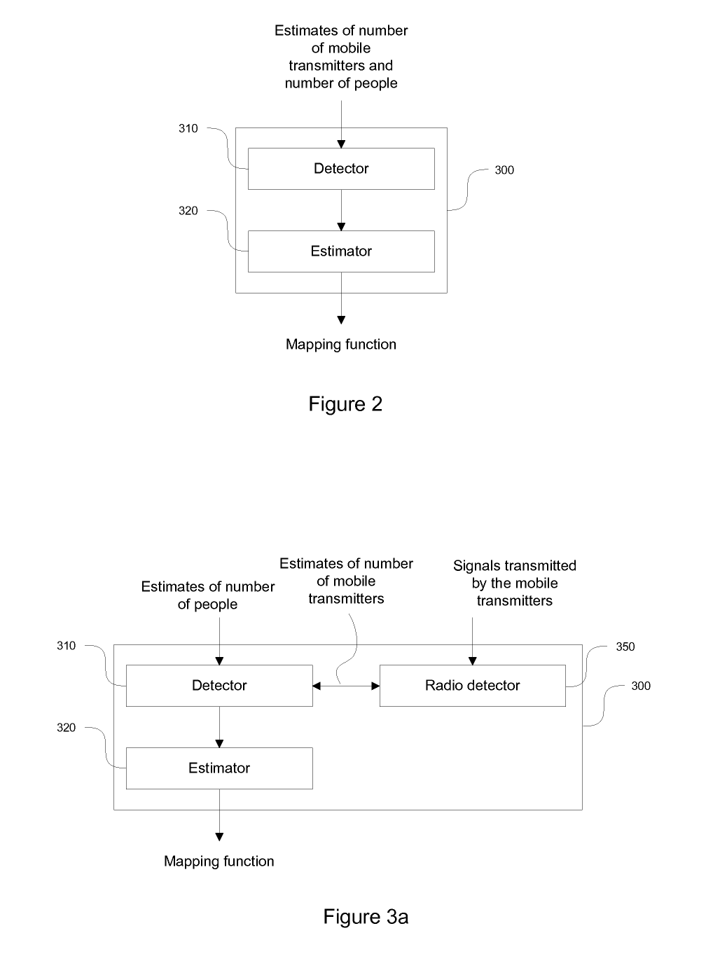

FIG. 2 schematically illustrates an apparatus 300 for estimating a number of people within a location. The apparatus 300 comprises a detector 310 and an estimator 320, operatively coupled to the detector 310. The apparatus 300 may comprise further components or units, such as a processor, a memory, a user interface, a communication interface, etc. In particular, the apparatus 300 may receive input from one or more external processing units and/or apparatuses and the apparatus 300 may provide output to one or more external processing units and/or apparatuses. The apparatus 300 may be for example the apparatus 150 of the exemplifying scenario 100 illustrated in FIG. 1.

The detector 310 is configured to obtain a plurality of estimates of the number of mobile transmitters and respective estimates of the number of people within a first location during a first period of time, wherein an estimate of the number of mobile transmitters comprises indications of the number of mobile transmitters of one or more different types. A mobile transmitter may be a part of a transceiver, i.e. a unit comprising both a transmitter and a receiver, or a mobile transmitter may be a dedicated transmitter. In particular, mobile transmitters of interest may be mobile wireless transmitters hosted by a handheld device such as a mobile phone, e.g. wireless local area network (WLAN) transmitters in accordance with the IEEE 802.11 standard, Bluetooth transmitters, Bluetooth low energy transmitters, cellular transmitters according to a GSM, a WCDMA or a LTE standard, radio frequency identification (RFID) chips operating in accordance with an electronic product code (EPC) standard or a near field communication (NFC) standard, etc. The first location may be for example the first location 112 of the exemplifying arrangement 100.

The estimator 320 is configured to determine a mapping function providing a mapping between an estimate of the number of mobile transmitters at a location and an estimate of the number of people at the location. The estimator 320 is configured to determine the mapping function on basis of the plurality of estimates of the number of mobile transmitters and the respective plurality of estimates of the number of people, and the mapping function is usable for determination of a second estimate of the number of people within a second location during a second period of time on basis of a second estimate of the number of mobile transmitters obtained at the second location during the second period of time. The second location may be for example the second location 114 of the exemplifying arrangement 100, or the second location may be (essentially) the same as the first location at a different period of time . . . .

The apparatus 300, for example the estimator 320, may be configured to provide the mapping function or parameters determining the mapping function as an output. The estimator 320 may be configured to provide the output to another processing unit of the apparatus 300 to provide the output to another apparatus and/or to store the output to a memory in the apparatus 300 or in another apparatus.

The detector 310 may be configured to obtain the plurality of estimates of the number of mobile transmitters of one or more types at a given moment of time such that an estimate comprises a separate indication of the number of mobile transmitters of each of the one or more types. The plurality of estimates may correspond to a plurality of moments of time during the first period of time denoted by T₁. Hence, assuming K estimates to be obtained for the period T₁, the detector 310 may be configured to obtain an estimate of the number of mobile transmitters at moments of time indicted by t₁, where i=1, 2, . . . , K. The estimates may be obtained for regularly or essentially regularly spaced moments of time, i.e. at tₘ=T₁/K intervals. Instead of regularly spaced moments of time, the detector 310 may equally well be configured to obtain the K estimates determined according to a different temporal pattern during the period T₁, e.g. at random intervals summing up to the duration of the period T₁. On the other hand, the number of estimates K during the period T₁ may not be a predetermined number but the detector 310 may be configured to obtain any number of estimates falling within the period T₁.

An estimate of the number of mobile transmitters may comprise indication of the overall number of mobile transmitters Nᵢ at the moment of time denoted by tᵢ. In case only a single type of mobile transmitters is considered or all mobile transmitters are considered as a single type, an estimate may comprise a single piece of information, i.e. Nᵢ indicating the number of mobile transmitters at time tᵢ.

Additionally or alternatively, an estimate of the number of mobile transmitters may comprise a separate indication of the number of mobile transmitters of two or more different types. Assuming two different types of mobile transmitters, an estimate of the number of mobile transmitters may comprise an indication of the number of mobile transmitters of a first type N_{i,1} at the moment of time denoted by tᵢ and an indication of the number of mobile transmitters of a second type N_{i,2} at the moment of time denoted by tᵢ. This generalizes into indications of L types of mobile transmitters with N_{i,j}, j=1, 2, . . . , L, indicating the number of mobile transmitters of the j:th type at time tᵢ.

The detector 310 may be configured to obtain the plurality of estimates of the number of mobile transmitters as pre-stored data, for example by accessing a database comprising such information. The database may be stored at the apparatus 300, the database may be hosted by a device hosting also the apparatus 300 or the database may be stored in a remote device, e.g. in a server in a network. The entries of the database, each corresponding to an observed or estimated number of mobile transmitters, may comprise for example information indicative of the time of observation and an estimate of the number of mobile transmitters of one or more different types. The detector 310 may be configured, for example, to obtain from the database the observations/estimates falling within the period T₁ on basis of the information indicative of the time of the respective observation.

Examples of databases comprising information that may be used as basis for deriving the plurality of estimates of the number of mobile transmitters include log-information of various WLAN access servers such as servers in accordance a RADIUS protocol and/or a Diameter protocol. Corresponding information may also be obtained for example from Address Resolution Protocol (ARP) table implemented in e.g. a server of a WLAN network. Accurate mobile transmitter detection from an ARP table can be constructed when ARP information is associated with idle time information of the MAC addresses listed in ARP table. The idle time information is typically available from the same WLAN network e.g. form a database in a server of the WLAN network.

Alternatively or additionally, the detector 310 may be configured to obtain the plurality of estimates of the number of mobile transmitters by scanning a predetermined frequency band or a number of predetermined frequency bands in order to detect one or more mobile transmitters and types thereof. The detector 310 may be configured store the information obtained by scanning for subsequent use by the apparatus 300. The stored information may comprise for example information indicative of the time of the scan and an estimate of the number of mobile transmitters of a number of types detected in the scan. The detector 310 may be configured to store the information obtained by scanning e.g. in a database of a type described hereinbefore located at the apparatus 300. Alternatively or additionally, the detector 310 may be further configured to provide the information obtained in the scan to a database hosted in server remote from the apparatus 300 to make the information available to other apparatuses.

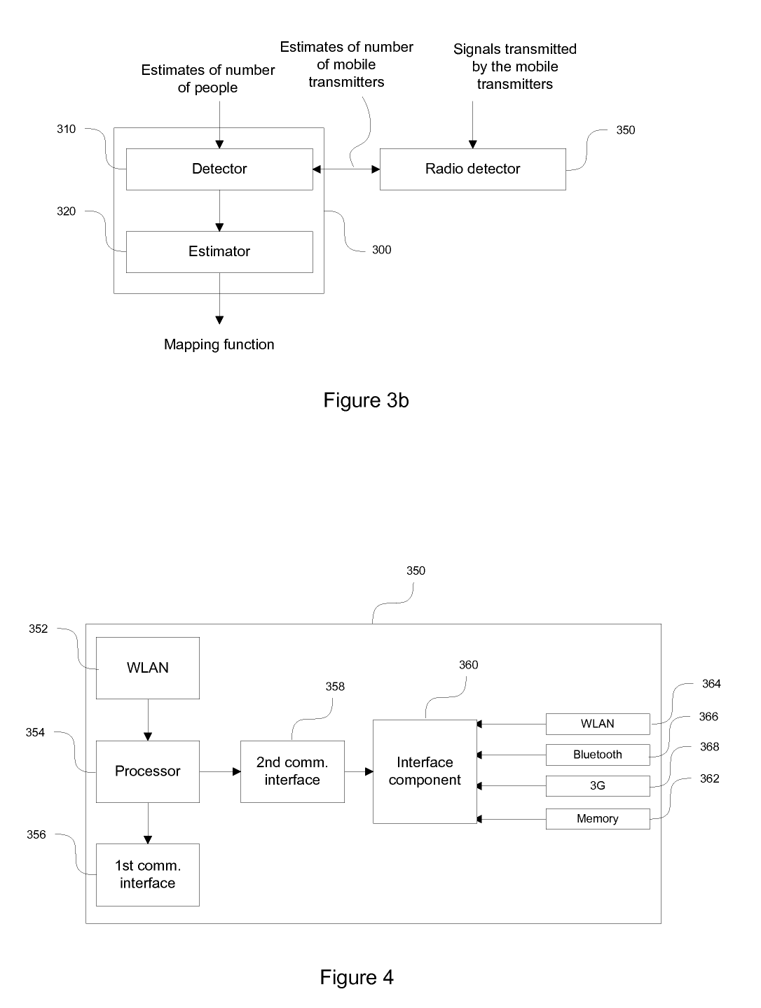

Instead of the detector 310 performing the scanning, the apparatus 300 may further comprise a radio detector 350, as schematically illustrated in FIG. 3a. The radio detector 350 may be configured to obtain the plurality of estimates of the number of mobile transmitters by scanning a predetermined frequency band or a number of predetermined frequency bands in order to detect one or more mobile transmitters and types thereof. Alternatively, the radio detector 350 may be provided as an apparatus separate from the apparatus 300 coupled to the apparatus 300, which hence may be configured to obtain the plurality of estimates of the number of mobile transmitters and types thereof from the radio detector 350. An example of such an arrangement is schematically illustrated in FIG. 3b. The radio detector 350 may be for example the radio detector 130 or the radio detector 130′ of the exemplifying arrangement 100 illustrated in FIG. 1.

The radio detector 350 may comprise a WLAN detector and a Bluetooth detector in a single apparatus, resulting in a number of advantages, as discussed hereinafter. An example of the radio detector 350 is schematically illustrated in FIG. 4.

The radio detector 350 comprises a WLAN receiver 352, a processor 354 and a first communication interface 356. The WLAN receiver 352 may be for example a dedicated WLAN receiver or implemented as part of a WLAN transceiver. The first communication interface 356 may be an Ethernet interface or other suitable communication interface enabling broadband communication with other apparatuses, e.g. via a packet switched network. In case the radio detector 350 is provided as an apparatus separate from the apparatus 300, the radio detector 350 may be configured to communicate with the apparatus 300 via the first communication interface 356. In particular, the radio detector 350 may be configured to provide the information regarding the plurality of estimates of the number of mobile transmitters to the apparatus 300 via the first communication interface 356.

The radio detector 350 may further comprise one or more further receivers, operatively coupled to the processor 354. The further receivers may comprise one or more of a second WLAN receiver 364, a Bluetooth receiver 366 and a cellular receiver 368, e.g. according to a GSM, WCDMA and/or a LTE standard. As a further example, the further receivers may comprise an RFID chips operating in accordance with an EPC standard or to a NFC standard. The further receivers 364, 366, 368 may be directly coupled to the processor 354, or the further receivers 364, 366, 368 may be coupled to the processor 354—and possibly also to the radio detector 350—via a second communication interface 358 and/or via an interface component 360 connected to the second communication interface 358. The second communication interface 358 may comprise, for example, one or more USB ports, and the interface component 360 may comprise a USB hub connected to a USB port of the second communication interface 358. The further receivers 364, 366, 368 may be provided as dedicated receivers or as parts of respective transceiver.

The radio detector may further comprise a memory 362, either directly connected to the processor 354 or connected to the processor 354 via the second communication interface 358 and/or via the interface component 360. The processor 354 may be configured to access the memory 360 to read and execute a computer program stored therein, the computer program comprising one or more sequences of one or more instructions that, when executed by the processor 354, cause the radio detector 350 to perform a process described in the following.

The processor 354 may be configured to cause the WLAN receiver 352 to perform WLAN detection and to cause the Bluetooth receiver 366 to perform Bluetooth detection. Advantageously, the processor 354 is configured to cause the radio detector 350 to contact a server, such as a backbone server, via the first communication interface 356 in order to obtain opt-in or opt-out rules providing an indication to include or disregard, respectively, a certain mobile transmitter and/or to obtain one or more mapping rules for mapping an obtained WLAN device address and an obtained Bluetooth device address to a single mobile device. An example of such mapping rule is the notion that a certain combination of organizationally unique identifiers (OUI) for a WLAN transmitter and a Bluetooth transmitter imply an existing mapping function between a WLAN address and a Bluetooth address of the same mobile device. The processor 354 may be configured to analyze detected WLAN and Bluetooth transmitters and assign the information that a certain pair of detected WLAN and Bluetooth transmitters is associated with a single mobile device. After the analysis the processor 354 may be configured to scramble (e.g. to perform a hash operation) the WLAN and Bluetooth addresses to ensure privacy: In other words, the radio detector 350 may be configured to refrain from transmitting or providing the detected WLAN and/or Bluetooth addresses from the radio detector 350.

The processor 354 may be further configured to obtain adaptive frequency hopping (AFH) information from the Bluetooth receiver 366 using the host control interface (HCI) command “Read AFH Channel Map” provided in the Bluetooth standard in order to determine the portions of the frequency band shared by the WLAN and the Bluetooth transmitters currently employed by the Bluetooth receiver 366. The processor 354 may be configured to cause the WLAN receiver 352 to allocate the time used for scanning the IEEE 802.11 RF channels of the shared frequency band based on the AFH Channel Map, i.e. on basis of the portions of the shared frequency band currently employed by the Bluetooth receiver 366. Consequently, the WLAN receiver 352 may be configured to put more emphasis on scanning those portions of the shared frequency band not currently used by the Bluetooth receiver 366.

In case the radio detector 350 is provided as an apparatus separate from the apparatus 300, the radio detector 350 may be configured to employ a WLAN transceiver comprising the second WLAN receiver 364 instead of the first communication interface 356 to communicate with the apparatus 300. In such a scenario the radio detector may be configured to neglect reporting the detection of the operation of the WLAN transceiver as a detected WLAN transmitter to the apparatus 300 and/or to the detector 310.

The classification of the mobile transmitters into one or more different types may involve classification of the observed mobile transmitters into a number of predetermined types. Consequently, in case one or more mobile transmitters not falling within any of the predetermined types is observed, such mobile transmitter may be for example classified to represent an additional type indicating the number of observed mobile transmitters not representing any of the number of predetermined types. As another example, observed mobile transmitters not representing any of the number of predetermined types may be ignored in the analysis. As a particular further example of the latter approach, the detector 310 may be configured to estimate only the number of mobile transmitters of a single predetermined type, whereas the mobile transmitters of other types are knowingly ignored in the estimation.

Alternatively, the classification of the mobile transmitters into one or more different types may involve classification of the observed mobile transmitter into all different types observed in the estimation. While this approach is likely to provide improved flexibility compared to relying on a number of predetermined types, the resulting analysis of results, namely determination of a mapping function (as described in detail hereinafter) may become more complex.

The classification of the mobile transmitters into one or more different types may involve classification of the mobile transmitters on basis of the communication technology employed by the mobile transmitter. Different access technologies may include for example WLAN access in accordance with the IEEE 802.11 standard, Bluetooth access, Bluetooth low energy access, cellular access using e.g. a GSM, a WCDMA or a LTE standard, RFID communication operating in accordance with an EPC standard or to a NFC standard, etc. In other words, the type of the mobile transmitter may be determined on basis of the type of the wireless access employed by the mobile device hosting the mobile transmitter.

The classification of the mobile transmitters into one or more different types may involve classification of the mobile transmitters on basis of an identification of the mobile transmitter and/or an identification of the mobile device hosting the mobile transmitter. Such identification may be obtained for example as part of a signaling message transmitted by a mobile transmitter. Examples of signaling messages suitable for identification purposes on basis of an identification of a mobile transmitter include probe requests according to an IEEE 802.11 protocol, Bluetooth inquire responses, Bluetooth LE (Low Energy) Advertising PDUs, location update messages at random access channel of a GSM/WCDMA/LTE standard, responses to a RFID reader, etc. An example of information that may be used for identification of a mobile transmitter includes an organizationally unique identifier (OUI), as known in the art, provided/transmitted by the mobile transmitter in one or more signaling messages originating therefrom. The identification may indicate e.g. the manufacturer of the transmitter and/or the mobile device hosting the mobile transmitter, a model of the transmitter and/or the mobile device hosting the mobile transmitter, etc. Further Bluetooth characteristics and/or Bluetooth Low energy characteristics may be obtained by performing the HCI command “HCI_Read_Remote_Supported_Features” in order to obtain a corresponding response.

The classification of the mobile transmitters into one or more different types may involve classification of the mobile transmitters on basis of an observed communication pattern employed by the mobile transmitter and/or the mobile device hosting the mobile transmitter.

The communication patterns considered in the classification may comprise, for example, one or more of the following: a mobile device operating as a mobile WLAN access point, a mobile device connected to a stationary WLAN access point, a mobile device connected to a mobile WLAN access point having a specific name, a mobile device broadcasting one or more WLAN probe requests, a mobile device responding to Bluetooth Inquiry Scan, a mobile device supporting a number of Bluetooth services, a mobile device operating in Advertising state according to a Bluetooth Low Energy Standard, a mobile device connected to a headset, a mobile device responding to a RFID reader, and a mobile device operating on a frequency band allocated to a specific operator.

As an example, a communication pattern employed by a WLAN transmitter may be identified e.g. by an analysis of one or more layer 2 control packets transmitted by the WLAN mobile transmitter in question. As another example, the Bluetooth device type and supported Bluetooth services of a Bluetooth transmitter may be obtained by sending a remote name inquiry to the Bluetooth transmitter in question and by reading the supported features of the Bluetooth mobile transmitter sent by the Bluetooth transmitter in question in response to the inquiry. As a further example, an active Bluetooth audio link may be observed on basis of a regular time division communication according to one or more of the Bluetooth HV3, HV2 and/or HV1 link protocols.

The detector 310 is configured to obtain the plurality of estimates of the number of people within the first location during the first period of time at the moments of time corresponding to the respective estimates of the number of mobile transmitters. Hence, with the duration of the first period of time T₁ and with K estimates to be obtained during the period T₁, the detector 310 may be configured to obtain an estimate of the number of people at moments of time indicted by tᵢ, where i=1, 2, . . . K. In other words, for each estimate of the number of mobile transmitters there is a corresponding estimate of the number of people detected in (essentially) the same location at essentially the same moment of time.

An estimate of the number of people may comprise indication of the overall number of people Mᵢ at the moment of time denoted by tᵢ. In case only a single class of people is considered or all observed/detected people are considered to belong to the same class, an estimate may comprise a single piece of information, i.e. Mᵢ indicating the number of people at time tᵢ.

Additionally or alternatively, an estimate of the number of people may comprise a separate indication of the number of people in two or more different classes. Assuming two different classes of people, an estimate of the number of people may comprise an indication of the number of people belonging to a first class M_{i,1} at the moment of time denoted by tᵢ and an indication of the number of people belonging to a second class M_{i,2} at the moment of time denoted by tᵢ. This generalizes into indications of J classes of people with M_{i,j}, j=1, 2, . . . , J, indicating the number of people in the j:th class at time tᵢ.

The detector 310 may be configured to obtain the plurality of estimates of the number of people for example by accessing a database comprising such information. The database may be stored at the apparatus 300, the database may be hosted by a device hosting also the apparatus 300 or the database may be stored in a remote device, e.g. in a server in a network. The database may be the same database comprising information regarding estimated number of mobile transmitters (described hereinbefore) or the database may be a separate from the database comprising information regarding estimated number of mobile transmitters. The entries of the database, each corresponding to an observed or estimated number of people, may comprise for example information indicative of the time of observation and an estimate of the number of people. The detector 310 may be configured, for example, to obtain from the database the observations/estimates falling within the period T₁ on basis of the information indicative of the time of the respective observation.

As an example, an estimate of the number of people stored in the database may be derived on basis of auxiliary data, available for example at one or more entry points to and/or at one or more exit points from a physical space comprising the first location or at another suitable location in view of estimating the number of people in the first location. Such auxiliary data may comprise a direct estimate of the number of people currently present in the first location, based e.g. on any technical means of people counting known in the art or based on data provided by a person or persons counting the number of people in the first location or people entering and/or exiting the first location. As another example, the auxiliary data may comprise information obtained at one or more ticket counters at one or more entry points to the first location or to a physical space comprising the first location.

As another example, the auxiliary data may comprise one or more images captured at the respective moment of time at the first location, e.g. at the moments of time indicted by tᵢ, where i=1, 2, . . . K, and there may be one or more images captured at a given moment of time tᵢ. As an example, an estimate of the number of people for the moment of time tᵢ may be determined by applying an image analysis arrangement to estimate the number of persons depicted in a single image captured at tᵢ. As another example, an estimate of the number of people for the moment of time tᵢ may be determined by applying an image analysis arrangement to estimate the number of persons depicted in two or more images captured at tᵢ. and hence determine two or more initial estimates and by determining the final estimate of the number of people at time tᵢ as an average of the two or more initial estimates. The average may be e.g. an arithmetic mean or a weighted average.

Image analysis arrangements for estimating the number of persons depicted in an image based on e.g. recognition of human faces and/or human figures in general are known in the art.

The one or more images captured at time tᵢ may originate from one or more imaging devices positioned in such a way with respect to the first location that images originating therefrom provide a field of view enabling determination of the number of people currently in the first location. Such imaging devices may comprise one or more digital still cameras or camera modules and/or one or more digital video cameras or video camera modules.

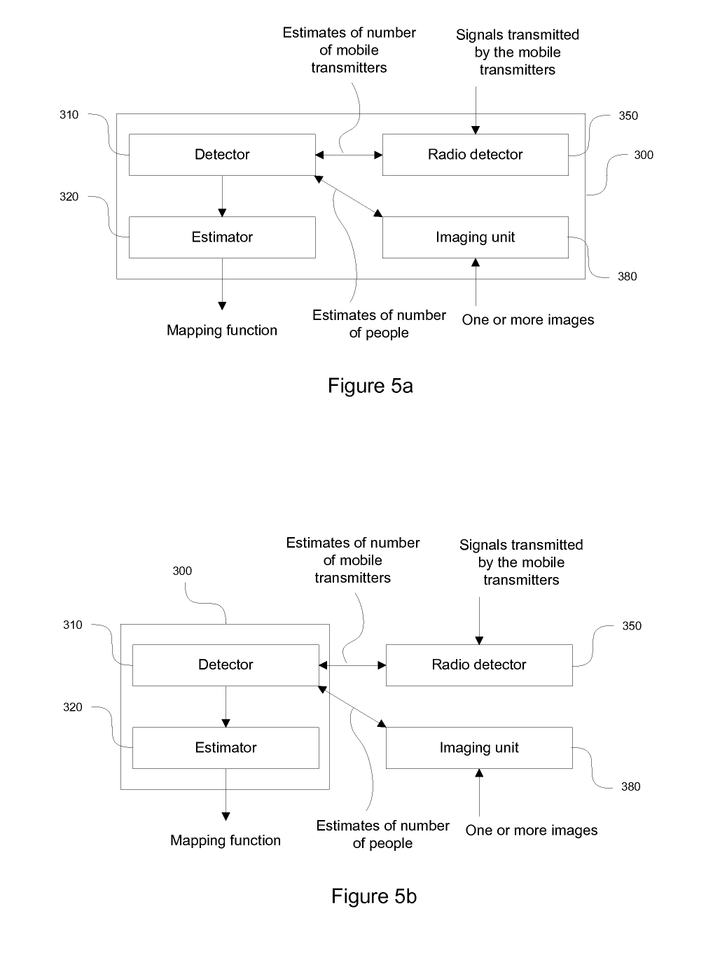

In this regard, the apparatus 300 may comprise an imaging unit 380 comprising one or more imaging devices configured to capture the one or more images to enable determination of the number of people in the first location, as described hereinbefore. An example of the apparatus 300 comprising also the imaging unit 380 is schematically illustrated in FIG. 5a. Moreover, the apparatus 300 may comprise one or more such imaging units, each comprising one or more imaging devices. Alternatively, the one or more imaging units 380 may be provided as an apparatus or apparatuses separate from the apparatus 300, which one or more imaging units are coupled to the apparatus 300. An example of such an arrangement is schematically illustrated in FIG. 5b. Hence, the apparatus 300 may be configured to obtain the one or more images captured at time tᵢ from the one or more imaging units 380. The imaging unit 380 may be for example the imaging unit 140 of the exemplifying arrangement 100 illustrated in FIG. 1.

As an example, the one or more imaging devices may be positioned such that they provide a field of view covering or essentially covering the first location, thereby enabling direct estimation of the number of people in the first location based on the estimated number of persons depicted in the one more images. As another example, the one or more imaging devices may be positioned at one or more entry points to and/or at one or more exit points from the first location or a physical space comprising the first location, thereby enabling estimation of the number of people in the first location on basis of the estimated number of persons entering the first location and estimated number of persons exiting the first location.

Instead of obtaining the plurality of estimates of the number of people by accessing a database, the detector 310 may be configured to carry out the analysis of one or more images captured at the first location at a given moment of time in order to determine an estimate of the number of people in the first location at the given moment of time, as described hereinbefore. Moreover, the detector 310 may be configured to perform such analysis for each of the moments of time indicted by tᵢ, where i=1, 2, . . . K. Alternatively, the detector 310 may employ a dedicated processing unit or processing entity to perform the image analysis. Such processing unit or processing entity may be provided as part of the apparatus 300, at a device hosting the apparatus 300, or at a device remote from the apparatus 300.

An estimate of the number of people in a location may comprise an indication or estimation of the number of people in a number of classes. Classification of the people into a number of classes may involve classification of the observed persons into a number of predetermined classes. Consequently, in case one or more persons not falling within any of the predetermined types are detected, they may be, for example, classified to represent an additional type indicating the number of observed persons not representing any of the number of predetermined types. As another example, persons detected not to represent any of the number of predetermined classes may be ignored in the analysis. As a particular further example of the latter approach, the detector 310 may be configured to estimate only the number of people of a single predetermined class, whereas the people of other classes are knowingly ignored in the estimation. Alternatively, the classification of the people into one or more different classes may involve classification of the observed persons into all different types encountered in the estimation.

The classification of people may be based, for example, on age, on gender, on general appearance, etc. of the persons, depending on the characteristics of the auxiliary data used as basis for estimating the number of people.

As an example, an estimate of the number of people based on the number of persons detected in one or more images may enable rather accurate classification of the people into males and females, together with an approximate classification into different age groups. The classification into different age groups may involve e.g. classifying the persons detected in one or more images into children, adults and seniors. As another example, the classification of one or more of the groups may involve further granularity, e.g. classification of the adults in the age groups of 18 to 30, 31 to 45 and 46 to 65. Image analysis arrangements capable of such classification are known in the art.

As another example, an estimate of the number of people based on information obtained at one or more ticket counters at one or more entrances to the first location or to a physical space comprising the first location may enable rough classification of the people into children, adults and seniors e.g. based on the different types of tickets sold at the one or more ticket counters.

As a further example, an estimate of the number of people based on information obtained from a person or persons counting the number of people in the first location or people entering and/or exiting the first location, if accompanied further data characterizing the observed people in the first location, may enable accurate classification into males and females, an approximate classification into different age groups, a classification on basis of the general appearance of the observed people, etc.

As referred to hereinbefore, the estimator 320 is configured to determine a mapping function providing a mapping between an estimate of the number of mobile transmitters at a location and an estimate of the number of people at the location. The estimator 320 is configured to determine the mapping function on basis of the plurality of estimates of the number of mobile transmitters and the respective plurality of estimates of the number of people, e.g. on basis of estimates of the number of mobile transmitters and respective estimates of number of people at the moments of time indicted by tᵢ, where i=1, 2, . . . K.

In particular, the estimator 320 may be configured to apply linear regression model to determine a parameter or parameters descriptive of the mapping between the observed estimates of the number of mobile transmitters and the respective plurality of estimates of the number of people, as described in detail in the following.

The estimator 320 may be configured to determine a mapping function for the overall number of people on basis of the plurality of the estimates of the overall number of mobile transmitters Nᵢ and the respective estimates of the overall number of people Mᵢ. Such a mapping function may be determined on basis of a function of the form indicated by the equation (1).

a*Nᵢ=Mᵢ (1)

where a denotes a mapping parameter to be determined. In particular, the estimator 320 may be configured to solve the parameter a on basis of a equation system (2)

$$\{ \begin{matrix}a * {N}_{1} = {M}_{1} \\ a * {N}_{2} = {M}_{2} \\ ⋮ \\ a * {N}_{K} = {M}_{K}\end{matrix} \qquad ( 2 )$$

The equation system (2) may be written in matrix form as

$$N * a = M ⇒ [ \begin{matrix}{N}_{1} \\ {N}_{2} \\ ⋮ \\ {N}_{K}\end{matrix} ] * a = [ \begin{matrix}{M}_{1} \\ {M}_{2} \\ ⋮ \\ {M}_{K}\end{matrix} ] \qquad ( 3 )$$

Since the functions of the form indicated in e.g. the equations (1) and (2) each comprise only a single unknown variable, the value of the parameter a may be determined for example solving a for each equation of the equation system (2) separately and determining the final value of parameter a as an average, e.g. as an arithmetic mean of the separately solved values of a.

Alternatively, the value of the parameter a may be determined using a least squares fit approach known in the art, for example by using the ordinary least squares (OLS) approach as

a=(N^{T}N)⁻¹N^{T}M (4)

Hence, in terms generally applied in context of linear regression the plurality of estimates of the number of mobile transmitters Nᵢ in vector N represent the explanatory variables, the plurality of estimates of the number of people Mᵢ in vector M represent the response variables, and the variable a represents the resulting regression coefficient.

A mapping function on basis of a function of the form indicated by the equations (1) to (4) may also be determined in case the plurality of estimates of the number of mobile transmitters comprises indications of the number of mobile transmitters of a single predetermined type while ignoring the observed mobile transmitters of other types, since in such a case a single estimate of a number of mobile transmitters, i.e. that of the single predetermined type, at time tᵢ is sufficient basis for determination of the mapping function.

The estimator 320 may be configured to determine a mapping function for the overall number of people on basis of the plurality of the estimates of the number of mobile transmitters of two or more types N_{i,j}, where j=1, 2, . . . , L indicates the type of the transmitter (as described hereinbefore) and the respective estimates of the overall number of people Mᵢ. Such a mapping function may be determined on basis of a function of the form indicated by the equation (5).

a₁*N_{i,1}+a₂*N_{i,2}+ . . . +a_{L}*N_{i,L}=Mᵢ (5)

where the parameters aᵢ denote mapping parameters to be determined. In particular, the estimator 320 may be configured to solve the parameters aᵢ on bases of a equation system (6)

$$\{ \begin{matrix}{a}_{1} * {N}_{1 , 1} + {a}_{2} * {N}_{1 , 2} + … + {a}_{L} * {N}_{1 , L} = {M}_{1} \\ {a}_{1} * {N}_{2 , 1} + {a}_{2} * {N}_{2 , 2} + … + {a}_{L} * {N}_{2 , L} = {M}_{2} \\ ⋮ \\ {a}_{1} * {N}_{K , 1} + {a}_{2} * {N}_{K , 2} + … + {a}_{L} * {N}_{K , L} = {M}_{K}\end{matrix} \qquad ( 6 )$$

The equation system (6) may be written in matrix form as

$$N * a = M ⇒ [ \begin{matrix}{N}_{1 , 1} & {N}_{1 , 2} & … & {N}_{1 , L} \\ {N}_{2 , 1} & {N}_{2 , 2} & … & {N}_{2 , L} \\ ⋮ & ⋮ & ⋱ & ⋮ \\ {N}_{K , 1} & {N}_{K , 2} & … & {N}_{K , L}\end{matrix} ] * [ \begin{matrix}{a}_{1} \\ {a}_{2} \\ ⋮ \\ {a}_{L}\end{matrix} ] = [ \begin{matrix}{M}_{1} \\ {M}_{2} \\ ⋮ \\ {M}_{K}\end{matrix} ] \qquad ( 7 )$$

The parameters aᵢ of the vector a may be solved for example using a least squares fit approach known in the art, for example by using the OLS approach as

a=(N^{T}N)⁻¹N^{T}M (8)

Hence, in terms generally applied in context of linear regression the plurality of estimates of the number of mobile transmitters N_{i,j} in matrix N represent the explanatory variables, the plurality of estimates of the number of people Mᵢ in matrix M represent the response variables, and the vector a represents the resulting regression coefficient.

The estimator 320 may be configured to determine a mapping function for the number of people of two or more classes on basis of the plurality of the estimates of the number of mobile transmitters of two or more types N_{i,j}, where j=1, 2, . . . , L indicates the type of the transmitter (as described hereinbefore) and the respective estimates of the number of people in two or more classes M_{i,j}, j=1, 2, . . . , J indicates the number of people in the j:th class at time tᵢ. Such a mapping function may be determined on basis of a function of the form indicated by the equation(s) (9).

$${a}_{1 , 1} * {N}_{i , 1} + {a}_{2 , 1} * {N}_{i , 2} + … + {a}_{L , 1} * {N}_{i , L} = {M}_{i , 1} \\ {a}_{1 , 2} * {N}_{i , 1} + {a}_{2 , 2} * {N}_{i , 2} + … + {a}_{L , 2} * {N}_{i , L} = {M}_{i , 2} \\ ⋮ \\ {a}_{1 , J} * {N}_{i , 1} + {a}_{2 , J} * {N}_{i , 2} + … + {a}_{L , J} * {N}_{i , L} = {M}_{i , j} \qquad ( 9 )$$

where the parameters a_{i,j} denote mapping parameters to be determined. Hence, a group of equations of the form indicated by the equations (9) is determined for each of the plurality of estimates. In particular, the estimator 320 may be configured to solve the parameters a_{i,j} for each equation of the equation(s) (9), i.e. for each value of j separately, along the lines described in equations (5) to (8) hereinbefore, thereby resulting in parameter vectors aⱼ, j=1, 2, . . . , J.

In cases where the plurality of estimates of the number of mobile transmitters of a first type may be considered to be more accurate or reliable than the plurality of estimates of the number of mobile transmitters of a second type, a Weighted Least Squares (WLS) based methodology may be applied as an alternative to an OLS based approach discussed hereinbefore in detail. In a WLS based approach, the equation (8) can be rewritten in the form

a=((WN)^{T}WN)⁻¹(WN)^{T}WM=(N^{T}W^{T}WN)⁻¹N^{T}W^{T}WM (10)

where W is the (symmetric, positive definite) weighting matrix, comprising weights assigned for the plurality of estimates of the number of mobile transmitters in the matrix N. Typically, the higher the accuracy or reliability of a given estimate of the number mobile transmitters, the higher is the weight assigned therefor.

An example of such a case where a WLS based approach may be suitable may be e.g. a scenario where the Bluetooth based detection can be considered to yield more accurate results than the WLAN based detection, thereby resulting in the plurality of estimates of the number of Bluetooth transmitters to be considered as more accurate/reliable than the plurality of estimates of the number of WLAN transmitters. Consequently, higher weights may be assigned to the estimates of the number of Bluetooth transmitters than for the estimates of the number of WLAN transmitters. A WLS based methodology may also be applied for example to weight earlier detections with a smaller weight, e.g. by applying a weight that is decreasing with increasing temporal distance from the moment of determining the mapping function. As a further example, additionally or alternatively, a WLS based approach may be applied to weight detections e.g. 24 hours and/or 7 days ago with a higher weight than the other detections, e.g. in order to derive a mapping function that emphasizes the plurality of estimates of the number of mobile transmitters observed (approximately) a day and/or a week ago to account for events that can be expected to occur on daily and/or weekly basis.

Instead of an OLS or a WLS based approach, any other linear regression approach or other statistical approach may be employed. Moreover, any other approach for solving the parameter a of the equation (3) or the parameter vector a of the equation (7) may be employed.

The estimator 320 may be configured to constantly update the mapping function as new estimates of the number of mobile transmitters and the respective estimates of the number of people become available. In particular, the estimator 320 may be configured recursively update the mapping parameters, e.g. the parameters a_{i,j} of the parameter vectors aⱼ, j=1, 2, . . . , J. Such recursive methods include general auto-regressive (AR) smoothing methods. In cases where the amount and ‘classification’ of people may change rapidly, a Kalman filter based approach may be used to dynamically adjust the mapping parameters of the mapping function.

The apparatus 300 may be further configured to apply the determined mapping function to determine a second estimate of the number of people within a second location during a second period of time on basis of a second estimate of the number of mobile transmitters obtained at the second location during the second period of time.

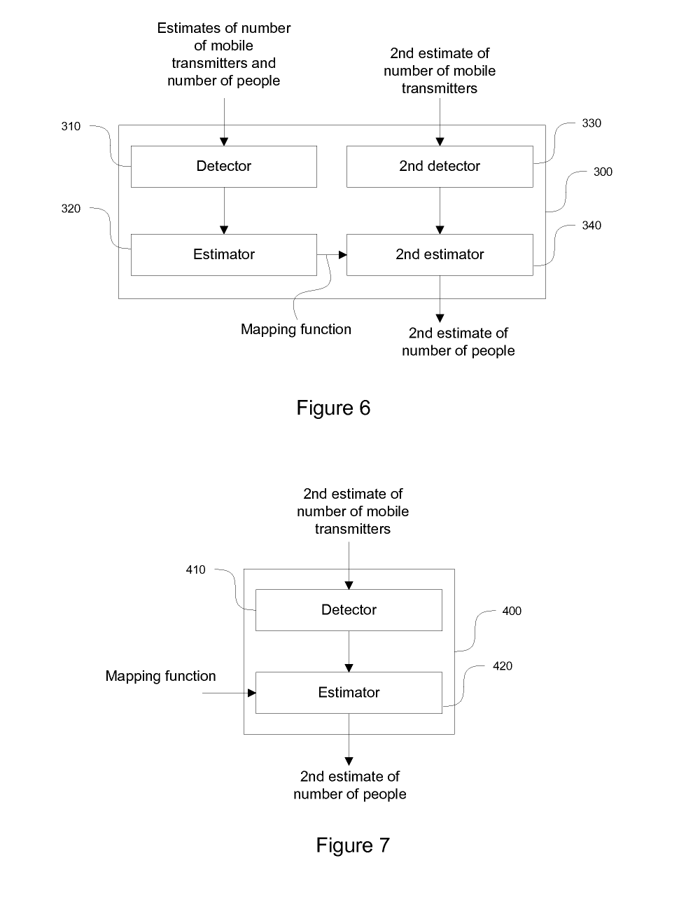

In this regard, the apparatus 300 may comprise a second detector 330, as schematically illustrated in FIG. 6. The second detector 330 may be configured to obtain a second estimate of the number of mobile transmitters within a second location during a second period of time, wherein the second estimate of the number of mobile transmitters comprises indications of the number of mobile transmitters of one or more different types. The considerations hereinbefore regarding obtaining the plurality of estimates of the number of mobile transmitters of one or more types and the considerations regarding the types of the mobile transmitters apply also to the second detector 330 obtaining the second estimate of the number of mobile transmitters. The second estimate of the number of mobile transmitters may comprise indications of L types of mobile transmitters with Xⱼ, j=1, 2, . . . , L indicating the number of mobile transmitters of the j:th type at the moment of time of the second estimate of the number of mobile transmitters.

The apparatus may further comprise a second estimator 340, as schematically illustrated in FIG. 6. The second estimator 340 is configured to determine a second estimate of the number of people within the second location during the second period of time on basis of the second estimate of the number of mobile transmitters within the second location during the second period of time by using a mapping function. The mapping function may be determined by the estimator 320.

The second estimator 340 may obtain the mapping function directly from the estimator 320, or the second estimator may be configured to obtain, e.g. read, the mapping function or a parameter or parameters descriptive thereof from a memory of the apparatus 300 or from a memory of another apparatus accessible by the second estimator 340.

The second estimator 340 may be configured to apply the mapping function based on the parameter a determined on basis of the equations (1) to (4) to determine the second estimate of the number of people Y on basis of the second estimate of the overall number of mobile transmitters or on basis of the second estimate of the number of mobile transmitters of a single predetermined type by

Y=X*a (11)

Alternatively or additionally, the second estimator 340 may be configured to apply the mapping function based on the vector a comprising the parameters aᵢ determined on basis of the equations (5) to (8) and/or (10) to determine the second estimate of the number of people Y on basis of the second estimate of the number of mobile transmitters of two or more types by

$$Y = X * a = [ \begin{matrix}{X}_{1} & {X}_{2} & … & {X}_{L}\end{matrix} ] * [ \begin{matrix}{a}_{1} \\ {a}_{2} \\ ⋮ \\ {a}_{L}\end{matrix} ] \qquad ( 12 )$$

Alternatively or additionally, the second estimator 340 may be configured to apply the mapping function based on the vectors aⱼ, j=1, 2, . . . , J comprising the parameters aᵢⱼ determined on basis of the equations (5) to (10) to determine the second estimate of the number of people in two or more classes Yⱼ, j=1, 2, . . . , J on basis of the second estimate of the number of mobile transmitters of two or more types by

$${Y}_{j} = X * {a}_{j} = [ \begin{matrix}{X}_{1} & {X}_{2} & … & {X}_{L}\end{matrix} ] * [ \begin{matrix}{a}_{1 , j} \\ {a}_{2 , j} \\ ⋮ \\ {a}_{L , j} \end{matrix} ] , j = 1 , 2 , … , J \qquad ( 13 )$$

The second location may be the same location as the first location or a different location, whereas the second period of time is typically different from the first period of time. The different periods of time may imply time periods of different duration and/or time periods starting or ending at different times.

While it is possible to assume general applicability of the mapping function determined on basis of the data originating from the first location and hence use the mapping function in a second location that has no physical or other known relationship with the first location, preferably there is a relationship between the first and second location. For example, the first and second locations may be locations within the same physical space as depicted in the exemplifying scenario 100 of FIG. 1, e.g. two retails stores of a shopping mall, two non-overlapping locations of a theme park, two movie theaters of a cinema multiplex, etc.

The second period of time typically occurs later than the first period of time. However, in case the second detector 330 is configured to process pre-stored data, thereby possible obtaining the second estimate of the number of mobile transmitters originating from a time period that precedes the first period time used as basis for determination of the mapping function, the second period of time may occur earlier than the first period of time. In particular, in case of the second location being different from the first location the second period of time may occur within the first period of time or the second period of time may be overlapping with the first period a time.

The operations, procedures and/or functions or a part thereof described hereinbefore in context of the second detector 330 may be performed by the detector 310 instead of the second detector 330. Similarly, the operations, procedures and/or functions or a part thereof described hereinbefore in context of the second estimator 330 may be performed by the estimator 320 instead of the second estimator 340.

FIG. 7 schematically illustrates an apparatus 400 for estimating a number of people within a location. The apparatus 400 comprises a detector 410 and an estimator 420, operatively coupled to the detector 410. The apparatus 400 may comprise further components or units, such as a processor, a memory, a user interface, a communication interface, etc. In particular, the apparatus 400 may receive input from one or more external processing units and/or apparatuses and the apparatus 400 may provide output to one or more external processing units and/or apparatuses.

In particular, the detector 410 may be configured to operate as the second detector 330 described hereinbefore in context of the apparatus 300. Moreover, the estimator 420 may be configured to operate as the second estimator 340 described hereinbefore in context of the apparatus 300.

The operations, procedures and/or functions assigned to the detector 310 and the estimator 320, as well as the operations, procedures and/or functions assigned to the second detector 330 and the second estimator 340 possibly comprised in the apparatus 300, may be divided between the units in a different manner. Moreover, the apparatus 300 may comprise further units that may be configured to perform some of the operations, procedures and/or functions assigned to the above-mentioned processing units.

On the other hand, the operations, procedures and/or functions assigned to the detector 310 and the estimator 320, as well as the operations, procedures and/or functions assigned to the second detector 330 and the second estimator 340 possibly comprised in the apparatus 300, may be assigned to a single processing unit within the apparatus 300 instead. In particular, the apparatus 300 may comprise means for obtaining a plurality of estimates of the number of mobile transmitters and respective estimates of the number of people within a first location during a first period of time, and means for determining a mapping function providing a mapping between an estimate of the number of mobile transmitters at a location and an estimate of the number of people at the location on basis of the plurality of estimates of the number of mobile transmitters and the respective plurality of estimates of the number of people for determination of a second estimate of the number of people within a second location during a second period of time on basis of a second estimate of the number of mobile transmitters obtained at the second location during the second period of time, wherein an estimate of the number of mobile transmitters comprises indications of the number of mobile transmitters of one or more different types. The apparatus 300 may further comprise means for obtaining the second estimate of the number of mobile transmitters within the second location during the second period of time. and means for determining the second estimate of the number of people within the second location during the second period of time on basis of the second estimate of the number of mobile transmitters within the second location during the second period of time by using the mapping function.

Similar considerations with respect to the operations, procedures and/or functions assigned to the processing units of the apparatus 400, i.e. the detector 410 and the estimator 420, apply. In particular, the apparatus 400 may comprise means for obtaining a mapping function configured to provide mapping between an estimate of the number of mobile transmitters at a location and an estimate of the number of people at the location, means for obtaining an estimate of the number of mobile transmitters within a second location during a second period of time, and means for determining an estimate of the number of people within the second location during the second period of time on basis of the estimate of the number of mobile transmitters within the second location during the second period of time by using the mapping function, wherein an estimate of the number of mobile transmitters comprises indications of the number of mobile transmitters of one or more different types.

The operations, procedures and/of functions assigned to the detector 310, the estimator 320, the second detector 330 and the second estimator 340 described hereinbefore may be distributed between two or more apparatuses. Consequently, a system or an arrangement for estimating a number of people within a location may be provided, the system or the arrangement comprising the detector 310, the estimator 320, the second detector 330 and the second estimator 340. Considerations with respect to the detector 310 performing some or all of the operations, procedures and/or functions described in context of the second detector 330 and/or the estimator 330 performing some or all of the operations, procedures and/or functions described in context of the second estimator 340 apply also to the system or the arrangement. The system or arrangement may further comprise the radio detector 350 and/or one or more imaging units 380.

The operations, procedures and/or functions described hereinbefore in context of the apparatus 300, 400 may also be expressed as steps of a method implementing the corresponding operation, procedure and/or function.

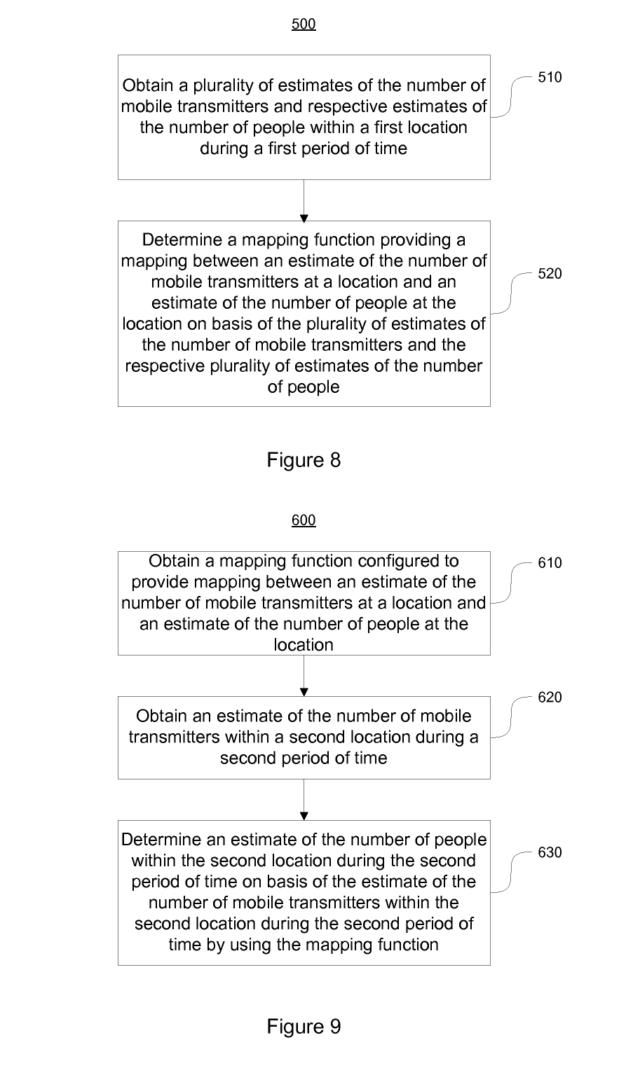

As an example, FIG. 8 illustrates a method 500 in accordance with an embodiment of the invention. The method 500 may be arranged to estimate a number of people within a location by carrying out operations, procedures and/or functions described in context of the apparatus 300. The method 500 comprises obtaining a plurality of estimates of the number of mobile transmitters and respective estimates of the number of people within a first location during a first period of time, wherein an estimate of the number of mobile transmitters comprises indications of the number of mobile transmitters of one or more different types, as indicated in step 510. The method 500 further comprises determining a mapping function providing a mapping between an estimate of the number of mobile transmitters at a location and an estimate of the number of people at the location on basis of the plurality of estimates of the number of mobile transmitters and the respective plurality of estimates of the number of people, as indicated in step 520. The mapping function may be usable for determination of a second estimate of the number of people within a second location during a second period of time on basis of a second estimate of the number of mobile transmitters obtained at the second location during the second period of time.

The method 500 may further comprise obtaining the second estimate of the number of mobile transmitters within the second location during the second period of time and determining the second estimate of the number of people within the second location during the second period of time on basis of the second estimate of the number of mobile transmitters within the second location during the second period of time by using the mapping function.

As another example, FIG. 9 illustrates a method 600 in accordance with an embodiment of the invention. The method 600 may be arranged to estimate a number of people within a location by carrying out operations, procedures and/or functions described in context of the apparatus 400. The method 600 comprises obtaining a mapping function configured to provide mapping between an estimate of the number of mobile transmitters at a location and an estimate of the number of people at the location, wherein an estimate of the number of mobile transmitters comprises indications of the number of mobile transmitters of one or more different types, as indicated in step 610. The method 600 further comprises obtaining an estimate of the number of mobile transmitters within a second location during a second period of time, as indicated in step 620, and determining an estimate of the number of people within the second location during the second period of time on basis of the estimate of the number of mobile transmitters within the second location during the second period of time by using the mapping function, as indicated in step 630.

The apparatus 300, 400 may be implemented as hardware alone, for example as an electric circuit, as a programmable or non-programmable processor, as a microcontroller, etc. The apparatus 300, 400 may have certain aspects implemented as software alone or can be implemented as a combination of hardware and software.

The apparatus 300, 400 may be implemented using instructions that enable hardware functionality, for example, by using executable computer program instructions in a general-purpose or special-purpose processor that may be stored on a computer readable storage medium to be executed by such a processor. The apparatus 300, 400 may further comprise a memory as the computer readable storage medium the processor is configured to read from and write to. The memory may store a computer program comprising computer-executable instructions that control the operation of the apparatus 300, 400 when loaded into the processor. The processor is able to load and execute the computer program by reading the computer-executable instructions from memory

While the processor and the memory are hereinbefore referred to as single components, the processor may comprise one or more processors or processing units and the memory may comprise one or more memories or memory units. Consequently, the computer program, comprising one or more sequences of one or more instructions that, when executed by the one or more processors, cause an apparatus to perform steps implementing the procedures and/or functions described in context of the apparatus 300, 400.

Reference to a processor or a processing unit should not be understood to encompass only programmable processors, but also dedicated circuits such as field-programmable gate arrays (FPGA), application specific circuits (ASIC), signal processors, etc. Features described in the preceding description may be used in combinations other than the combinations explicitly described. Although functions have been described with reference to certain features, those functions may be performable by other features whether described or not. Although features have been described with reference to certain embodiments, those features may also be present in other embodiments whether described or not.

1-30. (canceled)

31. A method for deriving a mapping function for estimating a number of people within a location comprising
obtaining a plurality of estimates of the number of mobile transmitters and respective estimates of the number of people within a first location during a first period of time,
determining a mapping function providing a mapping between an estimate of the number of mobile transmitters at a location and an estimate of the number of people at the location on basis of the plurality of estimates of the number of mobile transmitters and the respective plurality of estimates of the number of people for determination of a second estimate of the number of people within a second location during a second period of time on basis of a second estimate of the number of mobile transmitters obtained at the second location during the second period of time,
wherein an estimate of the number of mobile transmitters comprises separate indications of the number of mobile transmitters of two or more different types and that an estimate of the number of people comprises a separate indication of the number of people in two or more different classes,
wherein the mapping function is arranged to estimate the number of people in a class as a respective linear combination of the numbers of mobile transmitters of said two or more types, and wherein determining the mapping function comprises determining, for each of said two or more different classes of people, mapping parameters serving as coefficients of the respective linear combination, and
wherein the type of a mobile transmitter is determined at least on basis of an organizationally unique identifier, OUI, provided by the respective mobile transmitter.

32. A method according to claim 31, further comprising
obtaining the second estimate of the number of mobile transmitters within the second location during the second period of time and
determining the second estimate of the number of people within the second location during the second period of time on basis of the second estimate of the number of mobile transmitters within the second location during the second period of time by using the mapping function.

33. A method according to claim 31, wherein the plurality of estimates of the number of people in the first location during the first period of time are derived on basis of analyzing one or more images captured at the first location at respective moments of time.

34. A method according to claim 31, wherein the plurality of estimates of the number of people in the first location during the first period of time are derived on basis of information obtained at an entry point and/or an exit point of the first location.

35. A method according to claim 31, wherein determining the mapping function comprises applying a linear regression model to determine said mapping parameters.

36. A method for estimating a number of people within a location comprising
obtaining a predetermined mapping function configured to provide mapping between an estimate of the number of mobile transmitters at a location and an estimate of the number of people at the location,
obtaining an estimate of the number of mobile transmitters within a second location during a second period of time,
determining an estimate of the number of people within the second location during the second period of time on basis of the estimate of the number of mobile transmitters within the second location during the second period of time by using the mapping function,
wherein an estimate of the number of mobile transmitters comprises separate indications of the number of mobile transmitters of two or more different types and that an estimate of the number of people comprises a separate indication of the number of people in two or more different classes,
wherein the mapping function is arranged to estimate the number of people in a class as a respective linear combination of the numbers of mobile transmitters of said two or more types, and wherein determining the mapping function comprises determining, for each of said two or more different classes of people, mapping parameters serving as coefficients of the respective linear combination, and
wherein the type of a mobile transmitter is determined at least on basis of an organizationally unique identifier, OUI, provided by the respective mobile transmitter.

37. A method according to claim 31, wherein the estimates of the number of mobile transmitters are obtained by scanning a predetermined frequency band or a number of predetermined frequency bands in order to detect one or more mobile transmitters and types thereof.

38. A method according to claim 31, wherein the type of a mobile transmitter is determined on basis of the communication pattern employed by the respective mobile transmitter.

39. A method according to claim 38, wherein the communication pattern employed by a mobile transmitter is one of a plurality of predetermined communication patterns that comprise one or more of the following:
a mobile device operating as a mobile WLAN access point,
a mobile device connected to a stationary WLAN access point,
a mobile device connected to a mobile WLAN access point having a specific name,
a mobile device broadcasting one or more WLAN probe requests,
a mobile device responding to Bluetooth Inquiry Scan,
a mobile device supporting a number of Bluetooth services,
a mobile device operating in Advertising state according to a Bluetooth Low Energy Standard
a mobile device connected to a headset,
a mobile device responding to a RFID reader, and
a mobile device operating on a frequency band allocated to a specific operator.

40. A method according claim 31, wherein the plurality of predetermined classes are based on age, gender and/or appearance of persons observed/estimated in the respective location during the respective period of time.

41. A computer program product including one or more sequences of one or more instructions embodied on a computer-readable record medium which one or more instructions, when executed by one or more processors, cause an apparatus to at least perform the method of claim 31.

42. An apparatus for deriving a mapping function for estimating a number of people within a location, the apparatus comprising
a detector configured to obtain a plurality of estimates of the number of mobile transmitters and respective estimates of the number of people within a first location during a first period of time, and
an estimator configured to determine a mapping function providing a mapping between an estimate of the number of mobile transmitters at a location and an estimate of the number of people at the location on basis of the plurality of estimates of the number of mobile transmitters and the plurality of estimates of the number of people for determination of a second estimate of the number of people within a second location during a second period of time on basis of a second estimate of the number of mobile transmitters obtained at the second location during the second period of time,
wherein an estimate of the number of mobile transmitters comprises separate indications of the number of mobile transmitters of two or more different types and that an estimate of the number of people comprises a separate indication of the number of people in two or more different classes,
wherein the estimator is configured to derive a mapping function that is arranged to estimate the number of people in a class as a respective linear combination of the numbers of mobile transmitters of said two or more types, and wherein determining the mapping function comprises determining, for each of said two or more different classes of people, mapping parameters serving as coefficients of the respective linear combination, and
wherein the detector is arranged determine the type of a mobile transmitter at least on basis of an organizationally unique identifier (OUI) provided by the respective mobile transmitter.

43. An apparatus according to claim 42, further comprising
a second detector configured to obtain the second estimate of the number of mobile transmitters within the second location during the second period of time, and
a second estimator configured to determine the second estimate of the number of people within the second location during the second period of time on basis of the second estimate of the number of mobile transmitters within the second location during the second period of time by using the mapping function.

44. An apparatus according to claim 42, wherein the plurality of estimates of the number of people in the first location during the first period of time are derived on basis of analyzing one or more images captured at the first location at respective moments of time.

45. An apparatus according to claim 42, wherein the plurality of estimates of the number of people in the first location during the first period of time are derived on basis of information obtained at an entry point and/or an exit point of the first location.

46. An apparatus according to claim 42, wherein determining the mapping function comprises applying a linear regression model to determine said mapping parameters.

47. An apparatus for estimating a number of people within a location, the apparatus comprising
a detector configured to
obtain a predetermined mapping function configured to provide mapping between an estimate of the number of mobile transmitters at a location and an estimate of the number of people at the location, and
obtain an estimate of the number of mobile transmitters within a second location during a second period of time; and
an estimator configured to determine an estimate of the number of people within the second location during the second period of time on basis of the estimate of the number of mobile transmitters within the second location during the second period of time by using the mapping function,
wherein an estimate of the number of mobile transmitters comprises separate indications of the number of mobile transmitters of two or more different types and that an estimate of the number of people comprises a separate indication of the number of people in two or more different classes,
wherein the mapping function is arranged to estimate the number of people in a class as a respective linear combination of the numbers of mobile transmitters of said two or more types, and wherein determining the mapping function comprises determining, for each of said two or more different classes of people, mapping parameters serving as coefficients of the respective linear combination, and
wherein the detector is arranged determine the type of a mobile transmitter at least on basis of an organizationally unique identifier (OUI) provided by the respective mobile transmitter.

48. An apparatus according to claim 42, wherein the estimates of the number of mobile transmitters are obtained by scanning a predetermined frequency band or a number of predetermined frequency bands in order to detect one or more mobile transmitters and types thereof.

49. An apparatus according to claim 42, wherein the type of a mobile transmitter is determined on basis of the communication pattern employed by the respective mobile transmitter.

50. An apparatus according to claim 49, wherein the communication pattern employed by a mobile transmitter is one of a plurality of predetermined communication patterns that comprise one or more of the following:
a mobile device operating as a mobile WLAN access point,
a mobile device connected to a stationary WLAN access point,
a mobile device connected to a mobile WLAN access point having a specific name,
a mobile device broadcasting one or more WLAN probe requests,
a mobile device responding to Bluetooth Inquiry Scan,
a mobile device supporting a number of Bluetooth services,
a mobile device operating in Advertising state according to a Bluetooth Low Energy Standard
a mobile device connected to a headset,
a mobile device responding to a RFID reader, and
a mobile device operating on a frequency band allocated to a specific operator.

51. An apparatus according claim 42, wherein the plurality of predetermined classes are based on age, gender and/or appearance of persons observed/estimated in the respective location during the respective period of time.

52. A system for deriving and using a mapping function for estimating a number of people within a location, the system comprising
a first detector configured to obtain a plurality of estimates of the number of mobile transmitters and respective estimates of the number of people within a first location during a first period of time,
a first estimator configured to determine a mapping function providing a mapping between an estimate of the number of mobile transmitters at a location and an estimate of the number of people at the location on basis of the plurality of estimates of the number of mobile transmitters and the plurality of estimates of the number of people for determination of a second estimate of the number of people within a second location during a second period of time on basis of a second estimate of the number of mobile transmitters obtained at the second location during the second period of time,
a second detector configured to obtain a mapping function configured to provide mapping between an estimate of the number of mobile transmitters at a location and an estimate of the number of people at the location, and to obtain an estimate of the number of mobile transmitters within a second location during a second period of time; and
a second estimator configured to determine an estimate of the number of people within the second location during the second period of time on basis of the estimate of the number of mobile transmitters within the second location during the second period of time by using the mapping function,
wherein an estimate of the number of mobile transmitters comprises separate indications of the number of mobile transmitters of two or more different types and that an estimate of the number of people comprises a separate indication of the number of people in two or more different classes,
wherein the first estimator is configured to derive a mapping function that is arranged to estimate the number of people in a class as a respective linear combination of the numbers of mobile transmitters of said two or more types, and wherein determining the mapping function comprises determining, for each of said two or more different classes of people, mapping parameters serving as coefficients of the respective linear combination, and
wherein the first and second detectors are arranged determine the type of a mobile transmitter at least on basis of an organizationally unique identifier (OUI) provided by the respective mobile transmitter.
